(19) United States
(12) Patent Application Publication
(10) Pub. No.: US 2017/0232687 A1
(43) Pub. Date: Aug. 17, 2017

(54) Thermoplastic Composite In-Situ Melt Processing Method for Composite Overwrapped Tools

(71) Applicant: Toho Tenax America, Inc., Rockwood, TN (US)

(72) Inventor: Peter Shpik, Knoxville, TN (US)

(21) Appl. No.: 15/340,005

(22) Filed: Nov. 1, 2016

Related U.S. Application Data
(60) Provisional application No. 62/249,467, filed on Nov. 2, 2015.

(51) Int. Cl. B29C 70/34

(52) U.S. Cl. CPC B29C 70/34; B29K 2101/12

(57) ABSTRACT

An in-situ melt processing method for forming a fiber thermoplastic resin composite overwrapped workpiece, such as a composite overwrapped pressure vessel. Carbon fiber, or other types of fiber, are combined with a thermoplastic resin system. The selected fiber tow and the resin are prepared for impregnation of the two by the resin. The resin is melted and the carbon fiber is impregnated with the melted resin under pressure at the filament winding machine delivery head, under pressure and the molten composite is maintained and is applied to the heated surface of a workpiece. The surface of the workpiece is heated to the melting point of the thermoplastic resin so that the molten composite more efficiently adheres to the heated surface of the workpiece and so that the layers of composite remain molten resulting in better adherence of the layers to one another.

### CROSS-REFERENCE TO RELATED APPLICATIONS

This application claims the benefit of U.S. Provisional Patent Application No. 62/249,467, filed on Nov. 2, 2015, which is incorporated herein in its entirety by reference.

### STATEMENT REGARDING FEDERALLY SPONSORED RESEARCH OR DEVELOPMENT

Not Applicable

### BACKGROUND OF THE INVENTION

1. Field of Invention

The invention relates to a method of overwrapping a fiber resin composite over a tool. More particularly, it relates to an in-situ melt process of combining a fiber and a resin and applying the molten fiber resin complex to a heated tool such as a pressure vessel in one continuous operation.

2. Description of the Related Art

In the field of carbon fiber and resin composites, due to the higher strength to weight ratio of carbon fiber over steel, numerous tools and structural components, such as concrete pilings, aircraft wings and fuselages, automotive applications, and sporting goods are increasingly substituting carbon fiber and resin composites for steel. Composite Overwrapped Pressure Vessels, (“COPV”), are among the structures that make use of carbon fiber composite technology. And, it is known that there are a number of COPV designs in the market today. In this regard, Type II pressure vessels utilize hoop wraps of fiber over a metallic, usually steel, liner. Type III pressure vessels utilize both hoops and helical wraps of fiber over a metallic liner, usually aluminum, liner. Type IV pressure vessels utilize hoops and helical wraps over a plastic liner. And, Type V pressure vessels utilize hoop and helical fiber wraps over a liner-less tool that may incorporate a barrier film to prevent gas permeation. While the present invention has utility within these types of pressure vessels, as described herein, it also has utility in other types of tools that utilize a composite overwrap. The majority of these designs use a traditional wet winding process with carbon fiber and thermosetting resin. And, it is well known that the current materials and processes used to manufacture tanks today are costly and laborious.

The world-wide demand for fiber, including carbon fiber, for COPVs is growing. Fiber is used for tanks for CNG vehicles, pipelines, storage, and transportation for gases, including without limitation, CNG, Hydrogen, Nitrogen and other gases. Those skilled in the art expect this demand to continue to grow, driven mostly by the class 8 truck market, especially in the event that oil prices begin to rise again and the refueling infrastructure expands and matures.

As stated above, the main cost drivers for COPVs are material and manufacturing time. The current COPV manufacturing process consists of the following steps and results in a long process cycle for tank manufacturing:
Select one of several known methods of forming fiber/resin complex;
Wind fiber/resin complex onto the pressure vessel body;
Rotate pressure vessel until B-stage is achieved;
Cure cylinder at elevated temperature in oven; and
Clean-up cylinder and package.

If COPVs are to be widely adopted into the high volume markets, such as the transportation market, a higher speed, lower cost, manufacturing process (elimination of equipment and process steps) is necessary.

Carbon fiber is typically delivered as a single individual fiber filaments bundled up into a tow. Moreover, a tow may comprise as few as a thousand or as many as twenty-four thousand, or more, individual micron size carbon filaments. Depending upon the bandwidth of the tow as the fiber is being wrapped around a workpiece, the tow may be several hundred fibers thick. As used herein, “bandwidth” refers to the total spread width of a fiber tow. And, it is known that it is desirable and critical to maintain the individual filaments within a tow at a consistent tension as the tow is wound around a workpiece such as a pressure vessel. In this regard, it is known that if each individual filament is fixed in relation to each other, as with a rigid construction (plastic tape and towpreg) is wound around a radius, it is difficult to maintain consistent individual filament tension. This does not allow the individual filaments to slide relative to one another causing a phenomenon of catenary, creases, and wrinkles, which overall decreases the performance of the structure. This is because every individual filament does not contribute to the overall composite performance. That is, some individual filaments are subjected to the structural load while others are not being utilized. What happens is that some carbon fiber filaments fracture before the ultimate load is realized. While various known wet winding procedures Wet winding processes alleviate this problem to some extent because the individual filaments are allowed to slide relative to each other. Known wet winding processes suffer from other disadvantages including the necessity of using a low viscosity resins and prolonged curing times. Further, with known thermoplastic resin systems, a hot molten tape layer is applied to a cool solidified thermoplastic structure. Hence, one layer does not fully adhere to the previous layer, sometimes referred as a cold flow front. This interface is weak and will prematurely fail and prevent the composite to act as one continuous composite structure.

What is missing from the art is an in-situ melt process of combining a carbon fiber with a thermoplastic and applying the molten composite to a heated tool surface. Accordingly, one of the objects of the present invention is to create a method that reduces the overall cost of a COPV through the development of a thermoplastic design and a unique manufacturing process. A further object of the present invention is develop a thermoplastic system consisting of a unique rapid filament winding manufacturing process to produce composite structures. Still another object of the present invention is to use a selected fiber with a thermoplastic resin system using an in-situ process (combine both fiber and thermoplastic resin at the filament winding machine delivery head, an automatic tape laying head, or a tow laying system). Such an in-situ process, (combination of a thermoplastic film and carbon fiber at or near the delivery head to allow molten composite be applied to the tool surface), would reduce production time and cost. It will be recognized that reference to a “delivery head” is inclusive of filament winding machines, automatic tape laying systems, tow laying systems, and other systems, presently known or to be developed, for applying a molten thermoplastic composite to a tool.

### BRIEF SUMMARY OF THE INVENTION

The present invention is directed towards a method of creating a fiber resin composite overwrap for various workpieces that are known to be amenable to the composite overwrap process. While the present invention has utility in many types of applications that use composite overwrap, a primary usage is in the preparation of Type II, Type III, Type IV and Type V pressure vessels, referred to herein as composite overwrapped pressure vessels, or COPV's. Type III COPV's tend to be modulus driven applications while Type IV COPV's tend to be strength driven applications. Those skilled in the art recognize that strength driven applications call for fibers having different properties than fibers selected for modulus driven applications. The various physical attributes of various fibers are within the scope and spirit of the present invention. Carbon fiber, or other types of fiber, are combined with a compatible thermoplastic resin system. The selected fiber, whether carbon, glass, aramid, natural fiber, nano-fiber, or other known fibers are prepared for impregnation by a thermoplastic resin. The selected thermoplastic resin, whether in a pellet, tape, or thread configuration, is also prepared for processing. The carbon fiber and reduced viscosity, i.e. melted, thermoplastic resin are combined at the filament winding machine delivery head, under pressure, thereby forcing the resin into the fiber bundle. The molten fiber resin composite is then applied to the heated surface of a workpiece, such as a pressure vessel. The surface of the workpiece is heated to the melting point of the thermoplastic resin so that the molten composite more efficiently adheres to the heated surface of the workpiece and so that the layers of composite remain molten resulting in better adherence of the layers to one another. The molten layers are then compacted and consolidated under pressure. This compaction process removes entrapped air and consolidates the various layers of overwrapped fiber resin composite. Use of an in-situ melt process increases composite performance in that catenary, creases, and wrinkles are diminished or eliminated. This is because the individual filaments throughout the thickness of the tow bandwidth are allowed to slide across each other allowing for uniform tension within the fiber bundle of the fiber resin composite.

### BRIEF DESCRIPTION OF THE SEVERAL VIEWS OF THE DRAWINGS

The above-mentioned features of the invention will become more clearly understood from the following detailed description of the invention read together with the drawings in which:

FIGS. 1A-1F depict a flow-chart of the steps of the present invention.

### DETAILED DESCRIPTION OF THE INVENTION

The present invention is directed towards a method of creating a carbon fiber overwrap, such as is used for pressure vessels. Those skilled in the art will recognize that other types of items, referred to herein generally as workpieces, are often overwrapped with a fiber resin composite. The present invention is further directed towards using an in-situ process for combining both the fiber and thermoplastic resin at the filament winding machine delivery head, the delivery head of an automatic tape laying system, or the delivery head of a tow laying system, and applying the molten fiber thermoplastic resin complex to a heated workpiece, such as, but not limited to a pressure vessel.

Raw Materials

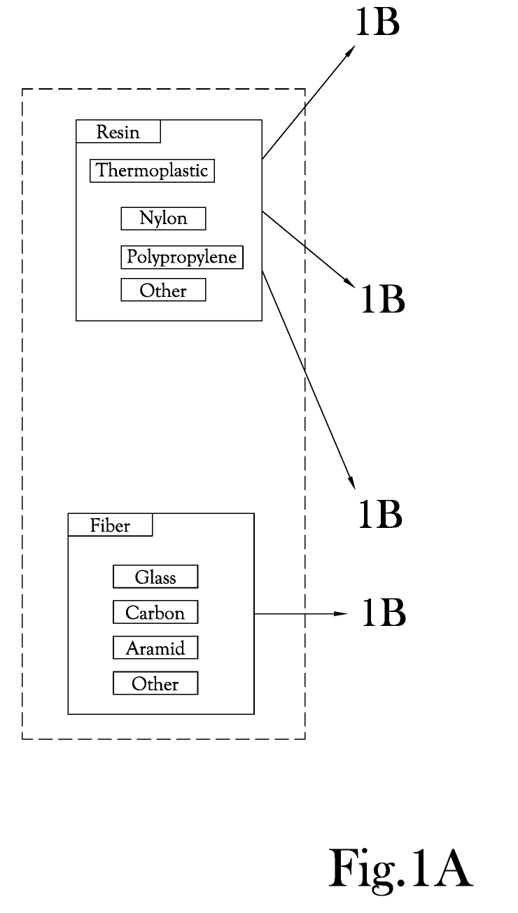

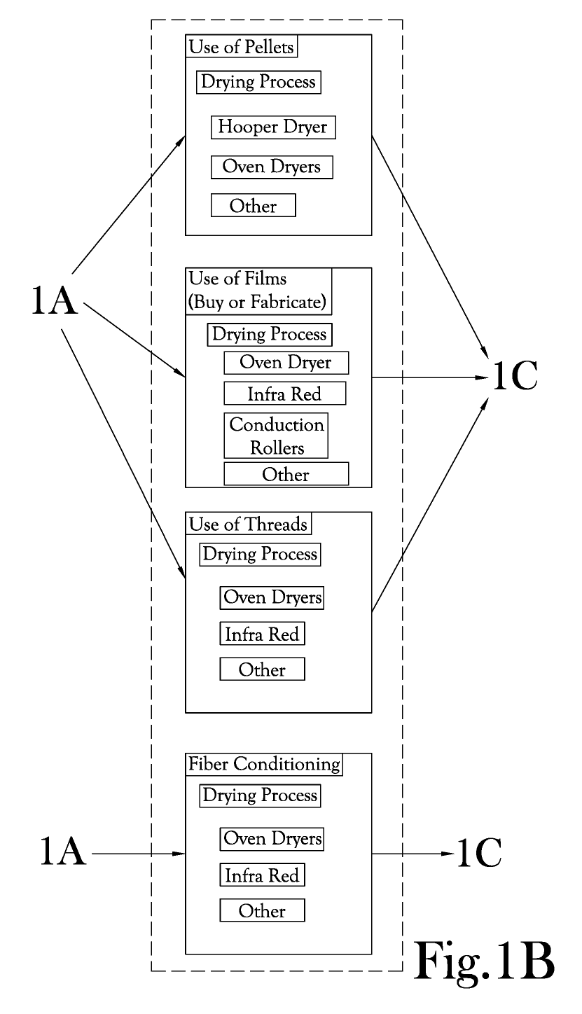

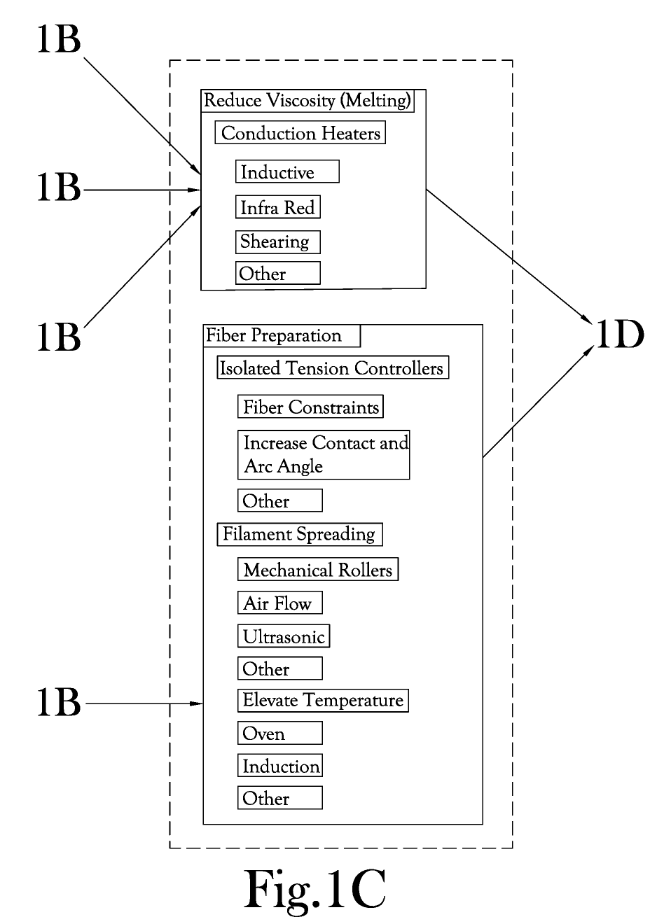

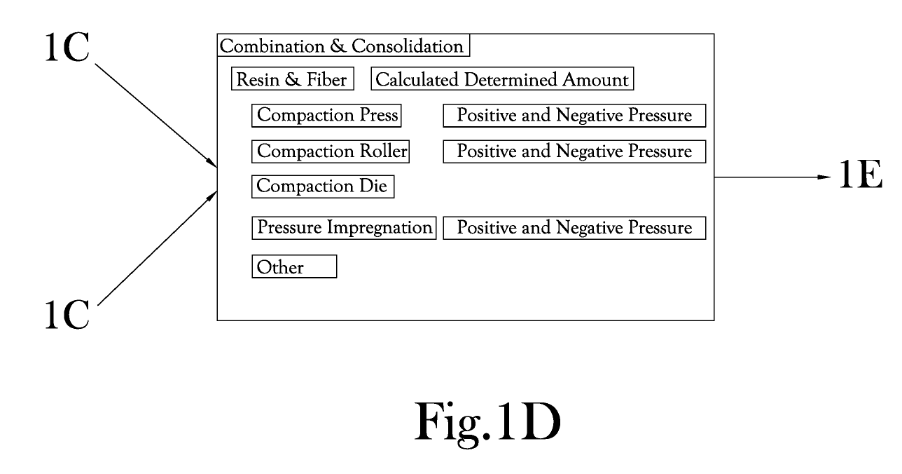

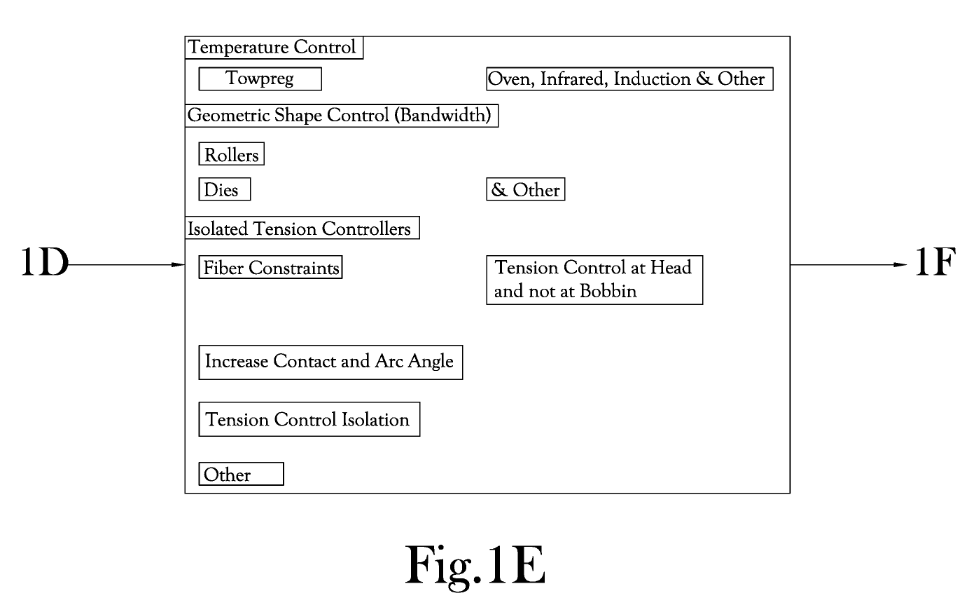

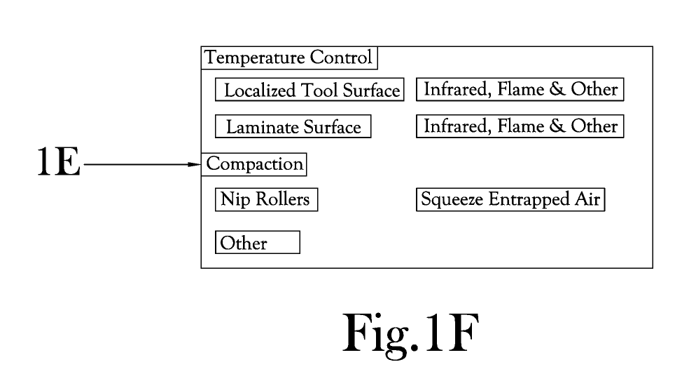

Those skilled in the art will readily recognize that the primary raw materials in a carbon fiber resin composite include the carbon fiber and the resin. The discussion to follow will address these components in greater detail and their relationship to one another is seen in FIGS. 1A-1F which depict a flow-chart of the steps of the present invention.

Carbon Fiber

There are a number of commercially available fibers that are used with composite overwrapped applications. In this regard, carbon fibers are typically chosen for Type IV COPV's that are typically used with compressed natural gas, (“CNG”), due to their strength. Type IV COPV's used with CNG are a strength driven application for composite overwrapping due to the fact that the plastic liner does not fatigue. Other applications may call for use of glass fiber, natural fiber, nano-fiber, or aramid fibers. And, those skilled in the art will recognize that there are other known types of fibers that are compatible with thermoplastic resin systems. Type III COPV's used for CNG are modulus driven applications because of the known tendency of aluminum liners to fatigue. Those skilled in the art recognize that strength driven applications call for fibers having different properties than fibers selected for modulus driven applications. The various physical attributes of various fibers are within the scope and spirit of the present invention.

It is known in the art that various commercially available fibers consist of sizing, which is not compatible with thermoplastic resin systems. Those skilled in the art recognize that sizing is a protective film used to protect the individual fiber filament and allow subsequent handling of the fibers; and that sizing promotes the adhesion between the fiber and matrix. Accordingly, in an exemplary embodiment, a fiber having sizing chemistries compatible with thermoplastic resins, such as polypropylene and nylon resins is selected. In an exemplary embodiment, the sizing is applied to the fiber during the carbon fiber manufacturing process, not after. Additionally, due to the known tendency of some fibers and some sizing chemistries to absorb moisture, any latent moisture must be removed by drying. Otherwise the moisture may be expelled during the process of combining the fiber and the resin resulting in porosity within the structure. This porosity results in poor product performance quality. In an exemplary embodiment, the fiber can be dried in oven dryers or infrared dryers. Those skilled in the art will recognize that there are other known methods of drying fiber.

Resin

In accordance with the present invention, thermoplastic resins, as opposed to epoxy resins, are preferred. There are many commercially available thermoplastic resins, including nylon resins, polypropylene resins, polyethylene resins, and polyetheretherketone, (“PEEK”), resin systems. Those skilled in the art will recognize that there are other commercially known thermoplastic resin systems that could easily be adapted to the in-situ process of the present invention. For Type IV pressure vessels the use of a low temperature thermoplastic is required due to the plastic liner that is being used. In an exemplary embodiment, polypropylene resin is utilized with plastic liner Type IV pressure vessels. In a further exemplary embodiment, for Type III pressure vessels, a higher temp resin system, such as a nylon resin system is selected.

Just as thermoplastic resins are available in a variety of different chemistries, these resins are available in a variety of physical forms. Thermoplastic resins are available in as pellets, films, and threads. While each of these can be adapted to be used in the present in-situ melt process, it is more economical to utilize a resin in a pellet form. As described above with fiber, it is important that any absorbed moisture be driven off by drying process. In this regard, Hooper dryers, oven dryers, conduction rollers, and infrared dryers can be utilized to dry the thermoplastic resin. Moisture can also be removed, as will be recognized by those skilled in the art, by the use of oven dryer systems.

Material Preparation

Subsequent to drying the thermoplastic resin, it is necessary to significantly reduce the viscosity of the resin material. The resin's minimum viscosity is reduced under pressure, at a selected temperature over a selected period of time. In this regard, time, temperature, and pressure are inter-dependent variables in the process of reducing the resin to its minimum viscosity. In an exemplary embodiment, shearing arbors are used to to decrease the viscosity of the resin by increasing friction, pressure, and time. Heat is applied by use of conduction heaters, induction heaters, infrared heaters, or other presently known, or subsequently discovered methods of heating a thermoplastic resin in order to reduce its viscosity. It will be understood that the desired temperature is dependent, first, on the resin chemistry selected. Once the viscosity is reduced to a desired level, the melted resin is combined with the fibers, further prepared as will be described below, under pressure in order to assure that the melted resin completely infiltrates the fiber tow.

Prior to being infiltrated by the melted resin, the fiber must be prepared. In order to provide optimum performance, the load-bearing fiber must be uniformly and equally spread to the desired bandwidth. Further, during the spreading process and during the infiltration step, care must be taken to insure that every individual filament within the carbon fiber tow are under the same tension. This critical step also allows easy resin infiltration into and around the individual filaments. In an exemplary embodiment, upstream tension and downstream tension are isolated from one another. Tension up stream of the impregnation area is kept at a minimum, to prevent fiber damage. Pressure is also kept at a minimum during impregnation process to allow easy infiltration of resin. However, after the impregnation process, pressure is increased to improve individual filament alignment and uniformity. Mechanical rollers, combs, air flow, and ultrasonic devices are known devices for spreading the raw fiber tow to the desired bandwidth and maintaining tension on the tow such that all fibers in the tow are under the same tension.

After the individual filaments of the fiber tow are uniformly and precisely spread to the desired bandwidth, the fiber tow must be heated to the same, or in some instances higher, temperature as the molten resin in order to assure adequate and complete impregnation. Those skilled in the art will recognize that the fiber tow can be heated by use of an induction furnace, an oven, or through the use of conduction rollers, or through other methods.

Material Combination—Resin Impregnation of Fiber

As alluded to above, after the fiber tow is prepared, i.e. dried, spread to the desired bandwidth, and heated, and the resin is at its minimum viscosity, the fiber tow is impregnated with the molten resin, under pressure in an exemplary embodiment. Impregnation under pressure, either positive pressure or negative pressure, can be accomplished by a compaction press, a compaction roller, a compaction die, or by pressure impregnation. In an exemplary embodiment, this step is accomplished immediately prior to application of the molten composite to a heated workpiece such as a pressure vessel. In this regard, in the in-situ process of the present invention, the fiber tow is impregnated with molten resin at, or in very close proximity to the filament winding head.

Material Application—Carbon Fiber In-Situ Process

Once the fiber and resin are combined, under pressure, to form a towpreg, the towpreg is kept at a constant bandwidth, tension, and temperature. As discussed above, tension is controlled and upstream tension is isolated from downstream tension. Bandwidth and temperature are controlled as discussed above. The location where the towpreg will be laid down is brought to, and kept at a temperature that is approximately the same as the melting point of the thermoplastic resin system in order to allow adhesion of one layer to another. This allows each individual filament to slide one relative to another thereby allowing each individual filament to be at the relative same tension during application of the tow. Further, maintaining a molten state as the layers are laid down allows entrapped air to escape. A heat source, such as induction coils, conduction rollers, flames, infrared heaters, by way of example and not limitation, is utilized to heat the pressure vessel or other tool being overwrapped. An external force is utilized to compact and consolidate the molten towpreg to the pressure vessel, or other tool being overwrapped. This compaction process removes entrapped air and consolidates the various layers of overwrapped fiber resin composite. A compaction roller, or similar device, is utilized for this compaction process.

It will be understood by those skilled in the art, that the entire pressure vessel could be brought up to temperature, or the heating could be isolated, or localized, to the portion of the tool surface undergoing the overwrap process. Further, the temperature is maintained as successive laminations of fiber resin composite are laid down.

In an exemplary embodiment, the carbon fiber, thermoplastic resin are combined at the filament winding machine to produce a thermoplastic composite that is then delivered to a workpiece, such as a pressure vessel while still molten. Those skilled in the art will recognize that other composite manufacturing equipment, such as automatic tape laying systems and other tow laying systems could be utilized with the process of the present invention. To achieve this objective, as stated above, the fiber and resin are heated and combined under pressure in order to impregnate the carbon fiber with molten thermoplastic resin. Then while it is molten, the molten composite matrix is applied to the surface of the tool (pressure vessel liner, shaft or other structure) which has also been heated to the melting point of the thermoplastic resin. In this regard, in an exemplary embodiment, a heating system, such as a flame or heated conduction roller system, is utilized to heat the surface of the tool. Those skilled in the art will recognize that other heat sources could be utilized. Carbon fibers quickly absorb this heat (Induction heat) and will automatically transfer this heat to the thermoplastic resin. The molten towpreg could then be compressed, by means of compaction rollers, dies, or other devices into tape form of the desired bandwidth. This hot composite, i.e. hot towpreg or molten hot tape, is then applied to a hot tool surface. By maintaining the working surface at an elevated temperature that approximates the melting point of the thermoplastic resin, successive layers adhere to one another. Thus, in the in-situ melt process of the present invention, the area of the tool or composite is heated prior to consolidation through the use of another heat source, which can be gas, inductive, infrared, or other known heat sources.

Use of an in-situ melt process also increases composite performance in that catenary, creases, and wrinkles are diminished or eliminated. In this regard, each individual filament within a carbon fiber tow prepreg is allowed to be at equal and uniform tension. This is achieved because the resin systems in the prepreg is allowed to be molten thereby allowing each individual filament within the tow to slide relative to one another, thereby achieving full potential of the fiber tow's mechanical properties. This is because the inner and outer layers of carbon fiber within the tow composite are allowed to slide across each other allowing for uniform tension within the fiber bundle of the fiber resin composite. Further, it will be recognized that the thermoplastic in-situ melt process described herein can be used in any composite manufacturing equipment. That is it can be used within a Fiber placement machine or other equipment such as pultrusion and so on.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. An in-situ melt process for creating a fiber resin composite overwrap, said in-situ melt process comprising the steps of:
selecting a fiber tow;
selecting a thermoplastic resin compatible with said selected fiber tow;
preparing said fiber tow for impregnation by said selected thermoplastic resin;
preparing said thermoplastic resin for impregnation into said fiber tow;
impregnating said prepared thermoplastic resin into said prepared fiber tow in close proximity to a filament winding head, thereby creating a molten fiber towpreg;
applying said molten fiber towpreg to a heated surface of a workpiece whereby a molten state of said molten fiber towpreg is maintained during a wrapping procedure thereby resulting in said molten composite more efficiently adhering to the heated surface of the workpiece and resulting in better adherence of successive molten composite layers to one another and further allowing individual filaments to slide relative to one another, effectively eliminating catenary, wrinkles, and creases within the composite; and
compacting and consolidating said molten fiber towpreg layers to one another under pressure thereby removing entrapped air.

2. The in-situ melt process for creating a fiber resin composite overwrap of claim 1 wherein said workpiece is a Type II pressure vessel.

3. The in-situ melt process for creating a fiber resin composite overwrap of claim 1 wherein said workpiece is a Type III pressure vessel.

4. The in-situ melt process for creating a fiber resin composite overwrap of claim 1 wherein said workpiece is a Type IV pressure vessel.

5. The in-situ melt process for creating a fiber resin composite overwrap of claim 1 wherein said workpiece is a Type V pressure vessel.

6. The in-situ melt process for creating a fiber resin composite overwrap of claim 1 wherein said fiber is selected from a group consisting of carbon fiber, glass fiber, natural fiber, nano-fiber, and aramid fiber.

7. The in-situ melt process for creating a fiber resin composite overwrap of claim 1 wherein said thermoplastic resin is selected from a group consisting of nylon resin, polypropylene resin, polyethylene resin, and polyetheretherketone resin.

8. The in-situ melt process for creating a fiber resin composite overwrap of claim 1 wherein said thermoplastic resin is in pellet form.

9. The in-situ melt process for creating a fiber resin composite overwrap of claim 1 wherein said thermoplastic resin is in tape form.

10. The in-situ melt process for creating a fiber resin composite overwrap of claim 1 wherein said thermoplastic resin is in thread form.

11. The in-situ melt process for creating a fiber resin composite overwrap of claim 1 wherein the step of preparing said fiber tow for impregnation by said thermoplastic resin includes the steps of drying said fiber tow, spreading said fiber tow to a selected bandwidth, and heating said fiber tow to a selected temperature, wherein said selected temperature is approximately a melting point of said selected thermoplastic resin.

12. An in-situ melt process for creating a fiber resin composite overwrap, said in-situ melt process comprising the steps of:
selecting a fiber tow;
selecting a thermoplastic resin compatible with said selected fiber tow;
preparing said fiber tow for impregnation by said selected thermoplastic resin, wherein the step of preparing said fiber tow for impregnation by said thermoplastic resin includes the steps of drying said fiber tow, spreading said fiber tow to a selected bandwidth, and heating said fiber tow to a selected temperature, wherein said selected temperature is approximately a melting point of said selected thermoplastic resin;
preparing said thermoplastic resin for impregnation into said fiber tow;
impregnating said prepared thermoplastic resin into said prepared fiber tow in close proximity to a filament winding head, thereby creating a molten fiber towpreg;
applying said molten fiber towpreg to a heated surface of a workpiece whereby a molten state of said molten fiber towpreg is maintained during a wrapping procedure thereby resulting in said molten composite more efficiently adhering to the heated surface of the workpiece and resulting in better adherence of successive molten composite layers to one another and further allowing individual filaments to slide relative to one another, effectively eliminating catenary, wrinkles, and creases within the composite; and
compacting and consolidating said molten fiber towpreg layers to one another under pressure thereby removing entrapped air.

13. The in-situ melt process for creating a fiber resin composite overwrap of claim 12 wherein said workpiece is selected from a group consisting of a Type II pressure vessel, a Type III pressure vessel, a Type IV pressure vessel, and a Type V pressure vessel.

14. The in-situ melt process for creating a fiber resin composite overwrap of claim 12 wherein said fiber is selected from a group consisting of carbon fiber, glass fiber, natural fiber, nano-fiber, and aramid fiber.

15. The in-situ melt process for creating a fiber resin composite overwrap of claim 12 wherein said thermoplastic resin is selected from a group consisting of nylon resin, polypropylene resin, polyethylene resin, and polyetheretherketone resin.

16. The in-situ melt process for creating a fiber resin composite overwrap of claim 12 wherein said thermoplastic resin is in pellet form.

17. The in-situ melt process for creating a fiber resin composite overwrap of claim 12 wherein said thermoplastic resin is in tape form.

18. The in-situ melt process for creating a fiber resin composite overwrap of claim 12 wherein said thermoplastic resin is in thread form.
